(19) United States
(12) Patent Application Publication
(10) Pub. No.: US 2010/0117412 A1
(43) Pub. Date: May 13, 2010

(54) DEVICE AND METHOD FOR ADJUSTING A SIDE CHEEK OF A SEAT

(76) Inventor: Sergej Bicker, Nuremberg (DE)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/528,997

(22) PCT Filed: Feb. 26, 2008
(86) PCT No.: PCT/EP08/01517

§ 371 Date: Oct. 26, 2009

(30) Foreign Application Priority Data
Feb. 28, 2007 (DE) 10 2007 009 891.1

(51) Int. Cl. B60N 2/44; A47C 7/14; A47C 3/00; A47C 7/46; A47C 31/12; B60N 2/02; B60N 2/64

(52) U.S. Cl. 297/217.1; 297/284.9; 297/284.6

(57) ABSTRACT

An adjusting device for adjusting a side wing (3) of a seat includes an adjusting element (2) to be coupled to the side wing, supporting means (25) for mechanically supporting the adjusting element (2), and pneumatically actuable positioning means (28) for positioning the adjusting element (21) in relation to the supporting means (25). The positioning means, for example an inflatable balloon (28), are coupled to the adjusting element (21) in order, when the positioning means (28) are actuated, to reposition the adjusting element (21) for adjusting the side wing (3).

The present invention relates to a device and a method for adjusting a side wing of a seat, in particular of a motor vehicle seat, and to a corresponding seat.

Side wings are used in a wide variety of motor vehicle seats, in particular in the case of sports seats, in order to provide additional lateral support for a person sitting on a seat. In particular when taking a bend, inertial forces acting on the seat occupant are actively absorbed by the side wings to prevent the person from moving laterally in relation to the seat. To this end, side wings are preferably arranged on the lateral edges of a back rest of the respective seat in order to provide lateral supporting faces for the upper body of the person sitting on the seat. However, many back rests provide only little lateral support, since vehicle seats are frequently designed such that they are suitable for vehicle occupants of various physiques, and side wings are therefore frequently arranged at a position far out on the back rests.

In order to allow the side wings to be adjusted individually to the size of the person sitting on the seat in each case, adjustable side wings have been developed. Various devices for adjusting the position or for altering the size of side wings are known from the art. For example, DE 199 50 702 A1 discloses a motor vehicle seat having inflatable side wings, in which air bags for inflating the side wings are provided in the side wings of the seat.

Adjusting devices known from the art for side wings, like that described in DE 199 50 702 A1, have the problem that in particular in the case of adjustment using air cushions the back rest contour is altered, rather than the width of the back rest being adjusted. Electromechanical adjusting devices for side wings sometimes have the problem that they are susceptible to damage if, as the seat occupant gets out, he or she touches the side wing and presses it outwards, since electromechanical adjusting devices frequently have only a small amount of play in order for the side wing to absorb the action of a force of this kind.

The object of the present invention is therefore to provide an improved adjusting device for a side wing of a seat and an improved method for adjusting a side wing of a seat. In particular, the object of the present invention is to provide an adjusting device for a side wing of a seat which enables the side wing to be adjusted with only a small alteration in the back rest contour.

According to the invention, this object is achieved by an adjusting device for a side wing of a seat and a method for adjusting a side wing of a seat as defined in the independent claims. The dependent claims define preferred or advantageous embodiments of the invention.

An adjusting device according to the invention for a side wing of a seat includes an adjusting element to be coupled to the side wing, supporting means for mechanically supporting the adjusting element, and pneumatically actuable positioning means for positioning the adjusting element in relation to the supporting means, the positioning means being coupled to the adjusting element in order, when the positioning means are actuated, to reposition the adjusting element for adjusting the side wing.

By combining a mechanical support of the adjusting element and a pneumatic actuation thereof by way of the positioning means, it is possible to adjust the side wing such that—in contrast to conventional pneumatic devices—the spatial arrangement of the side wing can be adjusted without at the same time inflating the side wing itself and hence alter its shape. By combining a mechanical support and a pneumatic actuation, the adjusting device according to the invention is furthermore less susceptible to damage in the event of a force acting on the side wing than conventional electromechanical adjusting devices.

The positioning means may in particular take the form of an inflatable balloon which has one or more chambers and is made from an elastic material and exerts a force on the adjusting element when it is inflated.

In accordance with an example embodiment, the adjusting element is supported pivotally on the supporting means, with the adjusting element including a first and a second portion which are arranged on opposite sides in relation to a point of action of the bearing, and with the positioning means being coupled to the second portion, which is different from the first portion, to be coupled to the side wing. As a result of this configuration, it is possible to avoid the need for the positioning means to be arranged in the side wing itself. For example, the positioning means, for example the inflatable balloon, may be arranged in the back rest of the seat and yet act mechanically on the adjusting element.

In accordance with a further example embodiment, the adjusting element is supported displaceably on the supporting means. In this arrangement, a respective stop may be provided for the positioning means on the supporting means and on the adjusting element, with the result that when the positioning means are actuated pneumatically, for example on inflation of the balloon, the positioning means are supported against the stop of the fixed supporting means and, as a result of a force exerted on the stop of the adjusting element, displace the latter in relation to the supporting means. The adjusting element may in this case have at least one curved, for example arcuate, portion. If the adjusting element is supported on the supporting means at its curved portion, then as a result of suitable shaping of the adjusting element a plurality of curved tracks can be defined along which the side wing can be adjusted.

The adjusting element may take the form of a curved wire or one or more metal or synthetic tubes, or may include these. A portion of the wire or the metal tube may have moulding around it. As a result of moulding around that portion of the adjusting element which comes into contact with the positioning means and/or which comes into contact with the side wing, it is possible to create a planar abutment surface for the positioning means and/or the side wing.

A seat according to the invention includes an adjusting device according to an example embodiment of the invention which is coupled to a side wing of the seat in order to adjust it. To actuate the adjusting device, compressed-air generation means, for example in the form of an electronic air pump or a compressor, which are triggered by electrical control means in dependence on a sensor signal may be provided. If the seat is furthermore provided with a pneumatically actuable lumbar support or another pneumatically actuable device, the latter may be actuated using the same compressed-air generation means as the side wing adjusting device according to the invention.

In a method for adjusting the side wing of a seat according to the invention, the side wing is adjusted in that a position of a mechanically supported adjusting element coupled to the side wing is adjusted pneumatically. The method may for example be used with the adjusting device according to the invention.

The present invention will mainly be applicable to vehicle seats but is not restricted thereto.

The present invention will be explained in more detail below with the aid of preferred example embodiments and with reference to the attached drawing.

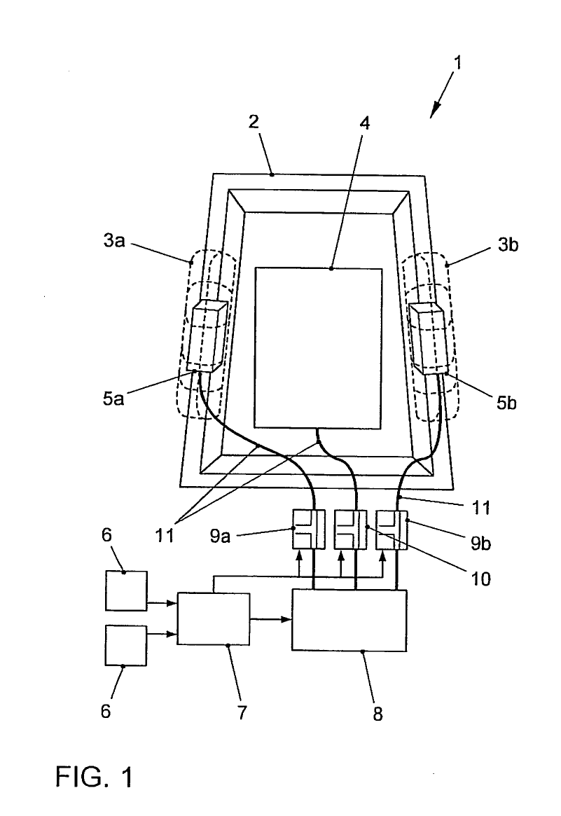

FIG. 1 is a schematic illustration of a seat having an adjusting device according to the invention, for a side wing.

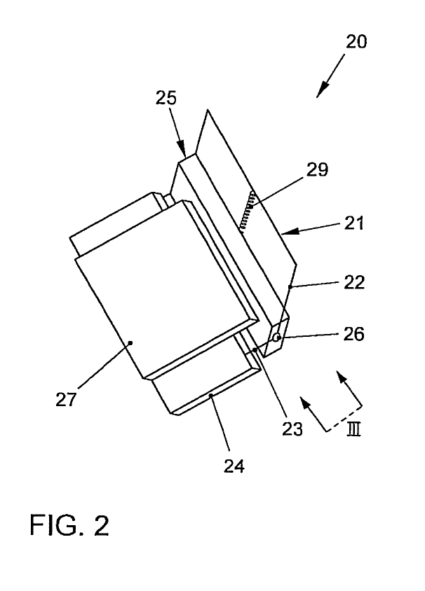

FIG. 2 is a perspective view of an adjusting device according to an example embodiment.

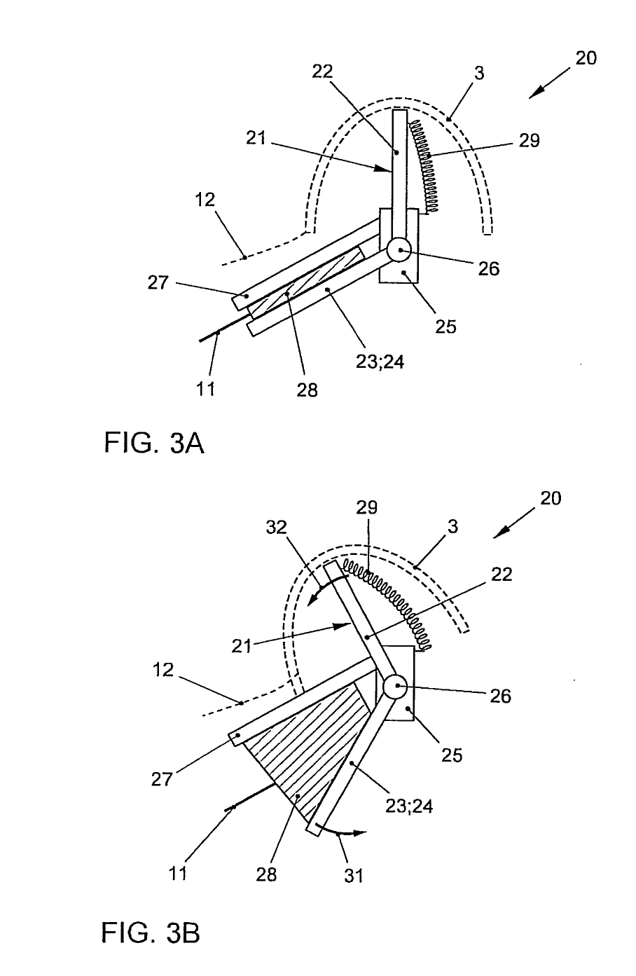

FIG. 3 shows schematically the adjusting device of FIG. 2 in a side view at various points in time during its actuation.

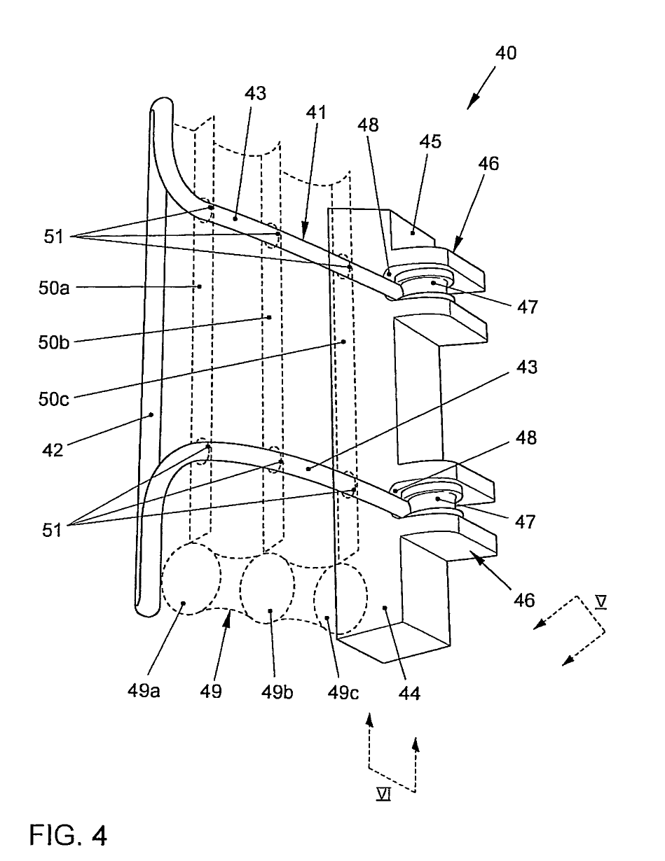

FIG. 4 is a perspective view of an adjusting device according to a second example embodiment.

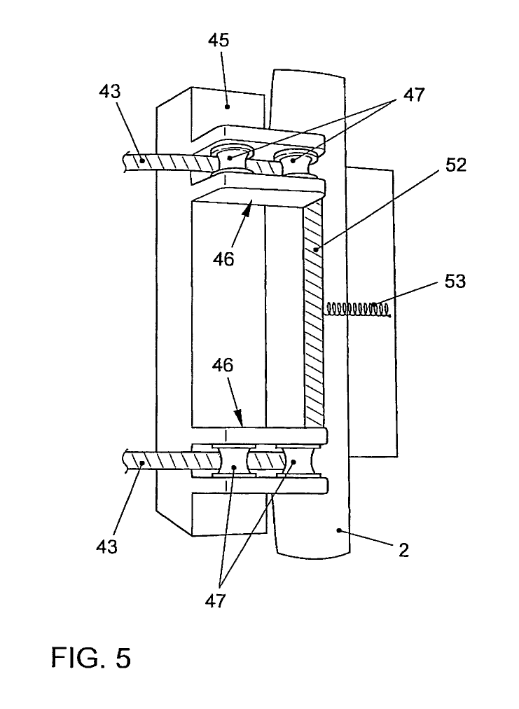

FIG. 5 is a further perspective view of the adjusting device of FIG. 4.

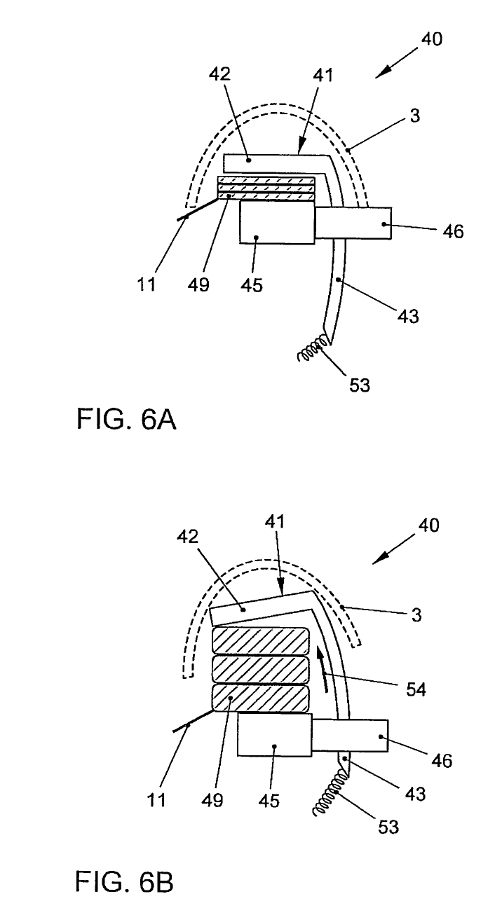

FIG. 6 shows schematically the adjusting device of FIG. 4 in a side view at various points in time during its actuation.

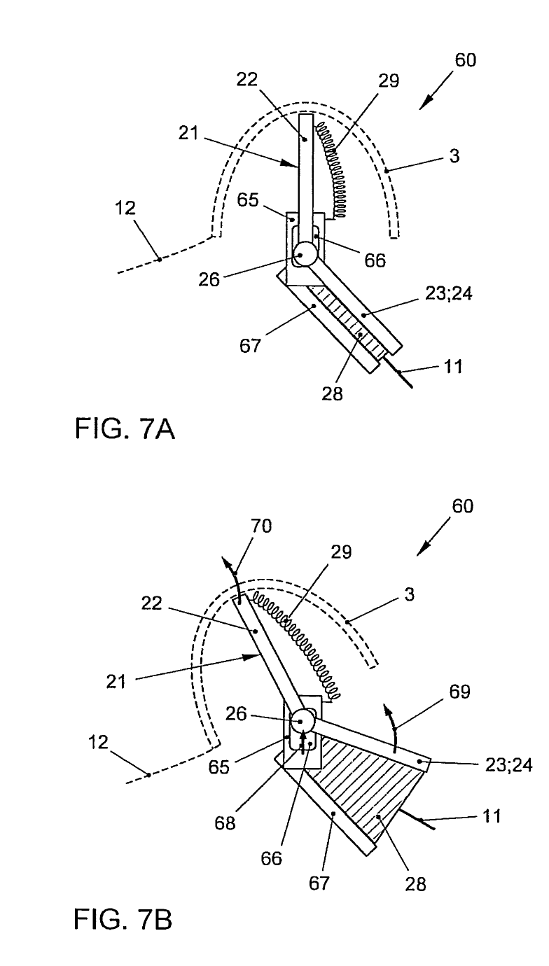

FIG. 7 shows schematically an adjusting device according to a third example embodiment, at various points in time during its actuation.

Referring to FIG. 1, first a seat having an adjusting device according to the invention, for adjusting a side wing, will be explained. FIG. 1 shows schematically a view of a back rest 1 of a seat, for example a motor vehicle seat. The back rest 1 includes a seat frame 2 on which two adjustable side wings 3a and 3b are provided. To adjust the side wings 3a and 3b, two side wing adjusting devices 5a and 5b are provided, coupled to the side wings 3a and 3b. The adjusting devices 5a and 5b according to the invention include a mechanically supported adjusting element, the position of which can be set pneumatically, as will be described in more detail below with reference to FIGS. 2-7.

To actuate the adjusting devices 5a, 5b, an electrical air pump or a compressor 8 is provided which supplies the adjusting devices 5a, 5b with a fluid, for example air, at positive pressure by way of controllable valves 9a, 9b and air hoses 11. The valves 9a, 9b also have an air vent duct in order to reduce positive pressure. Together with the valves 9a, 9b, the compressor 8 forms compressed-air generation means by means of which the adjusting device is pneumatically actuated.

To trigger the compressor 8 and the valves 9a, 9b, in the case of the seat in FIG. 1 an electronic control unit 7, for example a processor, is provided which controls the compressor 8 and the valves 9a, 9b in dependence on output signals from one or more sensors 6. The sensors may for example be a weight sensor for detecting the fact that a seat is occupied, an ignition switch sensor for detecting an operating state of a vehicle engine, a door sensor for detecting the opening and/or closing of a vehicle door, or a pressure sensor provided on the side wings, which detects the pressure exerted laterally by the side wings on a seat occupant. These sensors make so-called passive back rest width adjustment possible, in which the side wings are adjusted in the direction of the seat occupant when for example a vehicle is in motion and are retracted when the seat occupant wants to sit down on or leave the seat. The sensors 6 may, however, also include an acceleration sensor which for example detects accelerations acting laterally on the seat, with the adjusting devices 5a, 5b being adjusted in dependence on the lateral acceleration in order to give the seat occupant better lateral support. As a result of this so-called active back rest width adjustment, it is possible when taking a bend for the adjusting device according to the invention to selectively adjust the left-hand side wing 3b or the right-hand side wing 3a, in order to give the person in the seat better support to withstand the centrifugal force acting on him or her. It goes without saying that as an alternative, or in addition, manual triggering of the compressor 8 and the valves 9a, 9b by the seat occupant may also be implemented, for example by actuating a switch.

If a further pneumatically actuable device is provided on the seat, for example a pneumatically actuable lumbar support 4 shown in FIG. 1, this may also be provided with compressed air from the same compressor 8 which supplies compressed air to the side wing adjusting devices 5a, 5b.

Referring to FIGS. 2-7, example embodiments of adjusting devices according to the invention, for side wings of a seat, will be described below.

FIGS. 2 and 3 show an adjusting device 20 according to a first example embodiment. The adjusting device 20 includes an adjusting element 21, a mounting 25 on which the adjusting element 21 is mechanically supported and which serves as a supporting means for supporting the adjusting element 21, and an elastic balloon 28 (not illustrated in FIG. 2) which is arranged between a supporting plate 27 and a plate-shaped portion 24 of the adjusting element 21. The adjusting element 21 includes two portions 22 and 23 which are at an angle to one another, with the first portion 22 being coupled to the side wing 3 in the installed state of the adjusting device 20 and the second portion 23 abutting against the balloon 28. In the example embodiment illustrated, the adjusting element 21 takes the form of a bent wire with two portions 22, 23 at an angle to one another, with the plate 24 on which the balloon 28 acts being provided on the portion 23. The plate 24 may be mechanically secured to the portion 23 of the bent wire, for example by being screwed or glued, or it may take the form of a moulding around this bent wire portion. The portion 22 of the bent wire which is to be coupled to the side wing 3 may also have an element of planar shape, for example a plate (not illustrated in FIGS. 2 and 3) which is screwed on or glued on, or a moulding around it. Even if the bent wire portion 22 is illustrated in the shape of a U with equal legs, the portion 22 which makes contact with the side wing may have any other shape, for example it may be trapezoidal or have curved sides.

The adjusting element 21 is supported pivotally on the mounting 25 by means of pins 26. A helical spring 29 is suspended on the adjusting element 21 and the mounting 29 in order to bias the adjusting element 21 into a rest position and to absorb energy during a change in position of the adjusting element. While the mounting 25 in FIG. 2 is illustrated to be bar-shaped, it may also for example comprise a plurality of holding plates with which the pins 26 engage. The supporting plate 27 is fixed in its position in relation to the mounting 25 and, in the example embodiment illustrated, is fixedly connected thereto or is made integral therewith. In use, the mounting 25 of the adjusting device 20 is connected to the seat frame 2, for example by being screwed or welded or with holding brackets.

FIG. 3 is a schematic side view of the adjusting device 20 in different operating states in the direction labelled III in FIG. 2, that is to say from top in the installed state of the adjusting device 20. FIG. 3A shows a rest condition in which the balloon 28 is not under pressure and is fully compressed, with the result that the portion 23 of the adjusting element 21 is in a position close to the supporting plate 27. Accordingly, the side wing 3 which is coupled to the portion 22 of the adjusting element 21 is in a rest position. FIG. 3B shows an operating state in which the balloon 28 is inflated. Because the supporting plate 27 is arranged to be fixed in its location in relation to the mounting 25, when the balloon 28 is inflated the adjusting element 21 is pivoted about the position defined by the pins 26, as indicated by the arrows 31 and 32. As a result of pivoting the portion 22, the side wing 3 coupled to the portion 22 is also adjusted, being pivoted in the direction of the seat interior. As a result of an extension of the spring 29, a counter-force is generated which pivots the adjusting element 21 back into the rest position shown in FIG. 3A and at the same time empties the air out of the balloon 28 when the valve 9 is actuated for removing air from the balloon 28. When air is removed from the balloon 28, the side wing 3 also returns to its rest position accordingly.

As can be seen from FIG. 3, in the installed state the balloon 28 is arranged between the portion 23 of the adjusting element 21 and a seat surface 12. This arrangement is made possible because the two portions 22 and 23 of the adjusting element 21 are arranged on opposite sides of the bearing position defined by the pin 26, and it has the effect that the balloon 28 can be arranged at positions outside the side wing 3, for example in the interior of the seat. In the case of the example embodiment of FIGS. 2 and 3, inflation of the balloon 28 does not inflate the side wing 3 itself but adjusts it, allowing it substantially to retain its shape. While the balloon 28 in FIG. 1 is illustrated as a single-chamber balloon, it may also take the form of a multiple-chamber balloon.

FIGS. 4-6 show an adjusting device 40 according to a further example embodiment of the invention, with FIG. 4 being a perspective view, FIG. 5 being a further perspective view in the direction V in FIG. 4, and FIG. 6 being a schematic side view in the direction VI in FIG. 4.

The adjusting device 40 includes an adjusting element 41, a mounting 45 on which the adjusting element 41 is mechanically supported and which serves as a supporting means for supporting the adjusting element 41, and an elastic balloon 49 having a plurality of chambers 49a, 49b, 49c. The adjusting element 41 takes the form of one or more metal or plastic tubes and includes two curved portions 43 and a portion 42 which is at an angle to the curved portions and serves as an abutment surface and stop for the balloon 49, and in operation is coupled to the side wing 3. Tabs 50a, 50b, 50c are provided on those sides of the chambers 49a, 49b, 49c of the balloon 49 facing the curved portions 43 of the adjusting element 41, and these tabs have eyelets 51 through which the curved portions 43 pass, with the result that the balloon 49 is held against the adjusting element 41. The mounting 45 has two guide portions 46 for the two curved portions 43 of the adjusting element 41, each of which has a recess 48 and a roller 47 arranged adjacent thereto, or a plurality of rollers, with the curved portions 43 of the adjusting element 41 being guided between those sides of the rollers 47 facing the body of the mounting 45 and the body of the mounting 45. This allows the rollers 47 to facilitate displacement of the adjusting element 41 in relation to the mounting 45. The side face 44 of the mounting 45 facing the portion 42 of the adjusting element 41 also serves as an abutment surface or stop for the balloon 49.

FIG. 5 shows in more detail, in a further schematic perspective view in the direction labelled V in FIG. 4, the portion of the mounting 45 having the guide portions 46. Each of the guide portions 46 has a pair of rollers 47 which are arranged adjacent to one another in a longitudinal direction of the curved portions 43. Those ends of the curved portions 43 of the adjusting element 41 which are on the opposite side to the ends connected to the portion 42 are connected to one another by way of a transverse portion 52 to which an end of a helical spring 53 is coupled, for example being suspended thereon. The other end of the helical spring 53 is coupled to the seat frame 2, for example being suspended thereon, in order to bias the adjusting element 41 in the direction in which the portion 42 of the adjusting element 41 is arranged close to the mounting 45. The mounting 45 is mounted on the seat frame, for example by being screwed or welded or with holding brackets.

FIG. 6 is a schematic side view of the adjusting device 40 in different operating states in the direction labelled VI in FIG. 4, that is to say from top in the installed state of the adjusting device 40. FIG. 6A shows a rest condition in which the balloon 49 is not under pressure and is fully compressed, with the result that the portion 42 of the adjusting element is in a position close to the mounting 45. Accordingly, the side wing 3 which is coupled to the portion 42 of the adjusting element 41 is in a rest position. FIG. 6B shows an operating state in which the balloon 49 is inflated. Because one side of the multiple-chamber balloon 49 abuts against the side face 44 of the mounting 45 and is rested against it, when the balloon 49 is inflated the adjusting element 41 is displaced in relation to the mounting 45, as indicated schematically by the arrow 54. Accordingly, the side wing 3 is also adjusted along a curved track. The curve of movement of the portion 42 of the adjusting element 41 and the curve of adjustment of the side wing 3 are in this case substantially defined by the shape of the portions 43 of the adjusting element 41. Whereas, in the example embodiment illustrated in FIGS. 4-6, the portions 43 of the adjusting element are arcuate in shape, they may also have any other suitably defined shape. For example, only some of the portions 43 may be curved, whereas others are straight. As a result of a suitable shaping of the portions 43 and as a result of the arrangement of the guide portions 46 of the mounting, a plurality of desired curves of movement can be produced for the side wing 3, for example curves of movement in which the side wing 3, starting at the seat surface, is moved first substantially in a straight line and then along a curve to the interior of the seat.

When the balloon 49 is inflated, as a result of an extension of the spring 53 a counter-force is generated which displaces the adjusting element 41 back into the rest position shown in FIG. 6A and empties the air out of the balloon 49 when the valve 9 for venting air from the balloon 49 is actuated. When air is vented from the balloon 49, the side wing 3 also returns to its rest position shown in FIG. 6A accordingly.

Whereas, in the example embodiment illustrated in FIGS. 4-6, the adjusting element 41 takes the form of rigid tubes, it is also possible for the adjusting element to include tubes which may be displaced telescopically in relation to one another and which are extended when the balloon is inflated. In this case, the adjusting element 41 may be connected to the mounting 45 in fixed manner or displaceably.

FIG. 7 shows an adjusting device 60 according to a further example embodiment of the invention, in which an adjusting element is both displaced and pivoted, with FIG. 7A showing a rest condition and FIG. 7B showing an actuated condition. The adjusting device includes an adjusting element 21 configured as described with reference to FIGS. 2 and 3, and a mounting 65 which serves as a supporting means and has mounted thereon a supporting plate 67 and an elastic balloon 28 which is in turn arranged between the supporting plate 67 and the portion 23 of the adjusting element 21 which is not coupled to the side wing 3. The ends of a spring 29 are coupled to the adjusting element 21 and the mounting 65 respectively in order to bias the adjusting element 21 into the rest position shown in FIG. 3A.

The adjusting element 21 is supported pivotally on the mounting 65 by means of a pin 26. However, the pin 26 is mounted not only rotatably but also displaceably on the mounting 65. To this end, the mounting 65 has a slot opening 66 in which the pin 26 engages and in which it is guided. When the balloon 28 is inflated, as shown schematically in FIG. 7B, the pin 26 is displaced in the slot opening 66 and the adjusting element 21 is pivoted about the respective position of the pin 26. The displacing and pivotal movements are illustrated schematically by arrows 68 and 69 respectively. The two movements may take place at the same time, to a certain extent at the same time, or substantially sequentially, with the sequence of the two movements being determined among other things by the geometric arrangement of the adjusting element 41 and the supporting plate 67 and the properties of stiffness of the side wing 3. For example, in this way, and as illustrated schematically by the arrow 70, a movement of the side wing 3 starting at the seat surface 12 and running first substantially in a straight line and then in a curve in the direction of the interior of the seat may be implemented.

In each of the example embodiments described with reference to FIGS. 2-7, a positive pressure valve may be connected to the balloon which makes it possible to vent air from the balloon when the pressure in the balloon exceeds a particular value, which may occur for example if the seat occupant exerts a pressure on the side wing which is transferred to the balloon by way of the adjusting element. In this case, the action of a great force on the side wing by the occupant results only in the venting of air from the balloon and not in damage to the adjusting device.

Whereas in the example embodiments explained in detail above an elastic balloon was used, the positioning means may take the form of any other suitable device which is pneumatically actuable and can exert a force on the adjusting element.

The method according to the invention for adjusting side wings of a seat and the adjusting device according to the invention for a side wing are not restricted to use with side wings provided on a back rest. Rather, the method according to the invention and the adjusting device according to the invention may also be applied with seat wings or head rests of a seat. The present invention may be used with any seats, in particular vehicle seats, but is not restricted to the latter.

1. An adjusting device for a side wing of a seat,
comprising
an adjusting element to be coupled to the side wing,
a supporting device for mechanically supporting the adjusting element, and
a pneumatically actuable positioning device for positioning the adjusting element in relation to the supporting device, the positioning device being coupled to the adjusting element in order, when the positioning device is actuated, to reposition the adjusting element for adjusting the side wing.

2. An adjusting device according to claim 1,
wherein
the positioning device includes an inflatable balloon.

3. An adjusting device according to claim 1,
wherein
the adjusting element is supported pivotally on the supporting device.

4. An adjusting device according to claim 3,
wherein
a first portion of the adjusting element is to be coupled to the side wing, and in that a second portion of the adjusting element is coupled to the positioning device, with the first portion and the second portion being arranged on opposite sides of the adjusting element in relation to a point of action of a bearing.

5. An adjusting device according to claim 4,
wherein
the first portion and the second portion are arranged at an angle to one another.

6. An adjusting device according to claim 3,
wherein
in an installed state of the adjusting device in the seat, the positioning device is arranged between the portion of the adjusting element coupled to the positioning device and a seat surface.

7. An adjusting device according to claim 1,
wherein
the adjusting element is supported displaceably on the supporting device.

8. An adjusting device according to claim 7,
wherein
the adjusting element and the supporting device each have a stop for the positioning device.

9. An adjusting device according to claim 7,
wherein
at least one portion of the adjusting element is curved in shape.

10. An adjusting device according to claim 7,
wherein
the adjusting element includes a plurality of tubes which may be displaced telescopically in relation to one another, in order to alter a dimension of the adjusting element when the positioning device is actuated.

11. An adjusting device according to claim 1,
wherein
an energy storage device which is coupled to the adjusting element in order to absorb or release energy when the adjusting element is repositioned.

12. An adjusting device according to claim 11,
wherein
the energy storage device biases the adjusting element into a rest position.

13. An adjusting device according to claim 1,
wherein
the adjusting element includes a bent wire.

14. An adjusting device according to claim 13,
wherein
there is moulding around at least part of the bent wire.

15. A seat, comprising
an adjustable side wing, and
an adjusting device, comprising
an adjusting element to be coupled to the side wing,
a supporting device for mechanically supporting the adjusting element, and
a pneumatically actuable positioning device for positioning the adjusting element in relation to the supporting device, the positioning device being coupled to the adjusting element in order, when the positioning device is actuated, to reposition the adjusting element for adjusting the side wing,
with the adjusting element of the adjusting device being coupled to the side wing in order to adjust the side wing when the adjusting element is repositioned.

16. A seat according to claim 15, comprising
a compressed-air generation device which is coupled to the positioning device in order to actuate it pneumatically.

17. A seat according to claim 16, comprising
at least one sensor for detecting a condition of the seat or of a vehicle having the seat, and
an electronic control device which is coupled to the at least one sensor and the compressed-air generation device in order to control the compressed-air generation device in dependence on an output signal of the at least one sensor.

18. A seat according to claim 17,
wherein
the at least one sensor is selected from a group including a seat occupancy sensor, a door sensor, an ignition switch sensor and an acceleration sensor.

19. A seat according to claim 16, including
an actuable lumbar support, with the compressed-air generation device being coupled to the lumbar support in order to actuate it.

20. A seat according to claim 15,
wherein
the adjustable side wing is arranged on a back rest of the seat.

21. A seat according to claim 15,
wherein
the seat is a vehicle seat.

22. A method for adjusting a side wing of a seat, comprising
adjusting the side wing by repositioning a mechanically supported adjusting element which is coupled to the side wing, a position of the adjusting element being altered pneumatically in order to adjust the side wing.

23. A method according to claim 22,
wherein
the adjusting element adjusts the side wing along a curve which begins at a seat surface and includes first a substantially straight portion and then a curved portion directed to the interior of the seat.

24. (canceled)
